(19) United States
(12) Patent Application Publication
(10) Pub. No.: US 2026/0314744 A1
(43) Pub. Date: Oct. 15, 2026

(54) Overshoe with scent masking and associated methods of manufacture

(71) Applicant: Nature Tracks Inc., Montréal (CA)

(72) Inventors: Harry Avrith, Montréal (CA); Julian Beh-Pold, Montréal (CA)

(21) Appl. No.: 19/644,815

(22) Filed: Apr. 10, 2026

Related U.S. Application Data
(60) Provisional application No. 63/787,214, filed on Apr. 11, 2025.

(51) Int. Cl. A43B 5/18; A43B 3/16; A61L 9/01

(52) U.S. Cl. CPC A43B 5/18; A43B 3/16; A61L 9/01

(57) ABSTRACT

A disposable scent masking overshoe and associated methods of manufacture are provided for masking a human scent while walking in the wild field. The disposable scent masking overshoe is manufactured of a silicone polymer, a cross-linking agent, a reinforcing agent, and a catalyst, with or without natural scent additives. The disposable scent masking overshoe is easy to use and durable for at least one-day outdoor activities, achieving a balance between scent strength, walking performance, and durability.

This patent application claims priority to U.S. provisional patent applications 63/787,214 filed Apr. 11, 2025, the content of which is hereby incorporated by reference.

### TECHNICAL FIELD

The present invention relates to scent masking overshoes, and more particularly to overshoes for the hunter’s boots which enable the hunter to not leave a human scent while walking in the hunting area and hunting wild game.

### BACKGROUND ART

It is known that wild game and other animals have a keenly acute sense of smell, and the hunter’s natural human odors/scents can be detected by them, which causes the wild game to avoid the hunting area. Many scent masking means have been developed to prevent human odors from animal detection.

One known disposable scent reducing foot/shoe/boot cover is disclosed in US20110258874A, disclosing: scent adsorbing disposable and adjustable encapsulating foot/shoe/boot cover system for various hunters, photographers, military and medical personnel, paintball or other activities offering concealment and/or prevention of odorous detection by animals or protection from dangerous materials such as bacteria, viruses and the like when encountering animals, people or other. The cover may be solid in color or be camouflaged with various colored patterns and may be imprinted with indicia such as logos or advertisements. The cover being comprised of at least a layer of breathable material containing an odor adsorption means such as activated carbon or other; and may further be comprised of a water resistant or water-proof layer or shell enabling the user to position said product about a shoe, boot or the foot area of the user while performing an activity such as but not limited to hunting or during storage or travel. This layered boot cover structure of US20110258874A is not easy to put on the boots, and it may be too heavy to walk with.

Another known scent masking kit is disclosed in US20170142958A, disclosing: a scent masking kit for maintenance of a hunting environment. The hunter, before entering into the hunting environment opens an airtight sealed package and dons scent masking gloves and shoe covers contained therein, wipes masking scents on the contact surfaces of the gloves and shoe covers, and enters the hunting environment temporarily to maintain the area's equipment, and uses a kneeling pad when working close to the ground to avoid leaving human scent in the environment. Upon leaving the area, the hunter disposes of the kit components and thus is prevented from contaminating the hunting environment with human scents which may repel the wildlife. The materials utilized for the shoes may be a heavier material than that of the gloves to provide more durability walking in remote areas where wildlife is most likely to be encountered. The shoe cover is made of the same lightweight material, but has an additional coating or additional layers on the lower area to sustain the wear of walking and to prevent debris from tearing the fabric.

Another known scented footwear system for hunting is disclosed in US20150359212A, disclosing: A combination of a footwear sole or an over sole with a scented pad in which the scented pad is received on the bottom of the sole. The scented pad is retained by clip devices that are integrated into the sole during manufacture or added to a footwear sole or over sole. The scented pad is removable from the clip devices for replacement after use. The scented pad may receive scented chemical from a bottle that is attached to a receiver cap attached to the heel of the sole. The chemical transfers through a tube that is connected to a pump for dispersal of chemical from the tube onto the scented pad while a hunter is walking. The scented footwear system of US20150359212A is complicated in structure and easy to be broken while walking in the wild field.

It is desirable to provide a disposable scent masking overshoe for hunters, which should be easy to use and be durable for at least one-day outdoor activity, furthermore to provide a scented overshoe, achieving a balance between scent strength, walking performance, and durability.

### SUMMARY OF INVENTION

According to an embodiment of the invention, a method of manufacturing an overshoe for footwear, comprises the steps: mixing raw materials, comprising a silicone polymer, a cross-linking agent, a reinforcing agent, and a catalyst; molding the overshoe by one of: injecting the mixed material into a mold cavity; and compression molding the mixed materials in a mold cavity; curing the molded material by a cross-linking process; and removing the cured overshoe from the mold cavity.

In a preferable embodiment of the invention, the silicone polymer is a polydimethylsiloxane, being 84 to 96 weight percent of the materials; the cross-linking agent is a hydrogen silicone oil, being 1 to 8 weight percent of the materials; the reinforcing agent is a white fumed silica, being 3 to 15 weight percent of the materials; and the catalyst is one of platinum compounds, dibutyltin dilaurate, and stannous octoate, being 2 to 20 ppm.

In an optimal embodiment of the invention, the polydimethylsiloxane is 87 to 92 weight percent of the materials; the hydrogen silicone oil is 3 to 5 weight percent of the materials; the white fumed silica, is 5 to 10 weight percent of the materials; and the platinum compound catalyst, is 5 to 10 ppm.

The silicone polymer based disposable scent masking overshoes with the above formulas provide a good walking performance, tear resistance and good durability.

The elasticity of the overshoe could accommodate a range of boot types, and also lead to fewer sizing models if needed.

In another embodiment of the invention, the materials further comprise a scent additive, being 0.2 to 1 weight percent of the raw materials.

In an optimal embodiment of the invention, the materials further comprise a scent additive, being 0.5 to 0.8 weight percent of the raw materials.

In a preferable embodiment of the invention, the scent additive is one of the following flavors: vanilla, anise, licorice and synthetic formulas. The synthetic formulas could mimic the urine odor of the local wild animals.

This scented disposable scent masking overshoe achieves great scent retention, providing a good masking of human odor.

In a preferable embodiment of the invention, the cross-linking process is performed for 40 to 50 seconds, under the conditions of 145 to 155 degrees Celsius and pressure of 150 to 200 psi.

In another embodiment of the invention, the materials further comprise a UV anti-slip additive; and the method further comprises a step of UV curing.

In a preferable embodiment of the invention, the UV anti-slip additive, being 2 to 8 weight percent of the raw materials, comprises a silicone-modified acrylate oligomer and a photoinitiator.

In a preferable embodiment of the invention, the UV curing is performed by UV light source located at 7 to 20 cm from a sole bottom surface of the overshoe for 30 to 90 seconds.

In a preferable embodiment of the invention, the UV curing is performed by UV light source located at 10 cm from a sole bottom surface of the overshoe for 50 to 70 seconds.

In another embodiment of the invention, the disposable overshoe manufactured by the above method, has at least one of a front sole portion and a heel portion of the overshoe is thicker than an arch portion of the overshoe.

In another embodiment of the invention, the disposable overshoe has at least one anti-slip pattern being formed on the bottom surface of the overshoe.

The disposable overshoe with anti-slip features provides great walking performance in the wild field.

The overshoe developed according to the present invention achieves a great balance between walking performance and durable, it could last several days’ outdoor activities, and the term “disposable” only refers to single-use in the reason of hygiene.

Because of the good walking performance of the overshoe, the features as scent sealing, waterproof, anti-slip could provide other great use cases, such as donned on shoes or boots for a lot of outdoor activities, e.g. military, wildlife photography, camping, fishing etc.

### BRIEF DESCRIPTION OF DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an elevation view showing a scent masking overshoe, according to the present invention, with an anti-slip pattern being formed on its bottom surface.

FIG. 2 is a perspective view of the scent masking overshoe of FIG. 1.

FIG. 3 is a side view of the scent masking overshoe of FIG. 1, which covers a boot.

FIG. 4 is an elevation view showing the bottom of the overshoe and the boot of FIG. 3.

FIGS. 5a, 5b, 5c are other anti-slip pattern designs for the bottom of the overshoe.

FIG. 6 is a schematic diagram illustrating a method of producing the overshoe of FIG. 1 according to the present invention.

### DETAILED DESCRIPTION

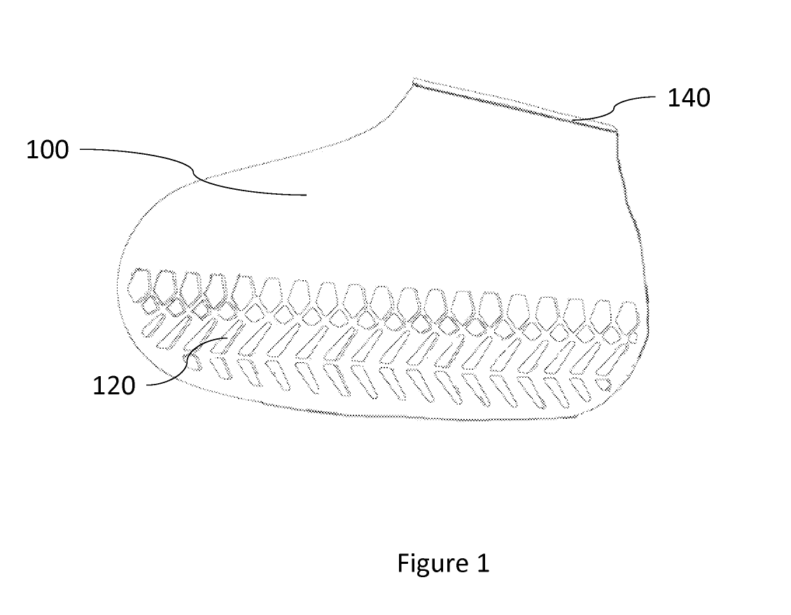

Referring to FIGS. 1-4, a disposable scent masking overshoe is provided according to the present invention, which can be provided to hunters in the wild to isolate the boots from the natural ground, thereby covering up the smell of human activities. Furthermore, natural scents can be added to the material of the disposable overshoe to better mask the human odor.

As a disposable overshoe for hunters, the material and structure of the overshoe is well designed after a plurality of experiments and comparisons, for ensuring at least one-day outdoor activity in the wild.

FIG. 1 shows a scent masking overshoe 100 before being donned onto a boot. The scent masking overshoe 100 has an opening 140 for a boot being passed into, and the overshoe 100 has an anti-slip pattern structure 120 formed on its bottom surface, so that the anti-slip pattern structure 120 overlays the sole bottom of the boot in order to create better anti-slip performance when walking in the wild.

The opening 140 has a structural reinforced rim to provide two main functions: to increase the strength of the opening to prevent tearing while donning; to facilitate donning and doffing.

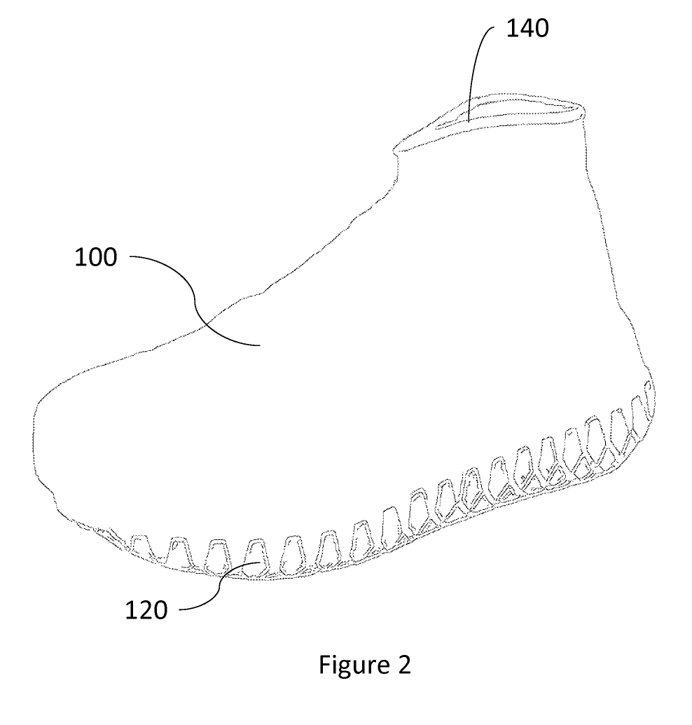

FIG. 2 shows a perspective view of the scent masking overshoe 100 before being donned onto a hunter’s boot.

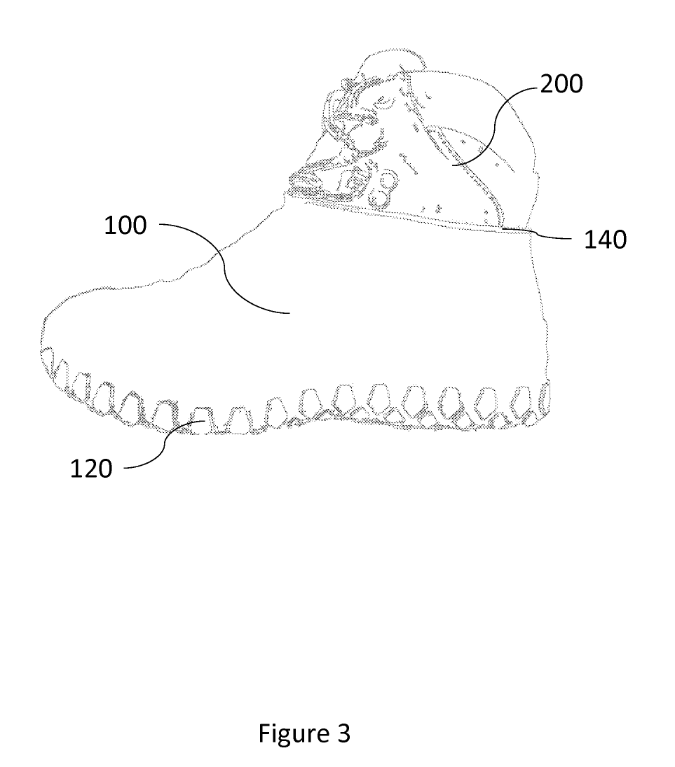

FIG. 3 shows a side view of the scent masking overshoe 100 of FIG. 1, which covers a boot 200.

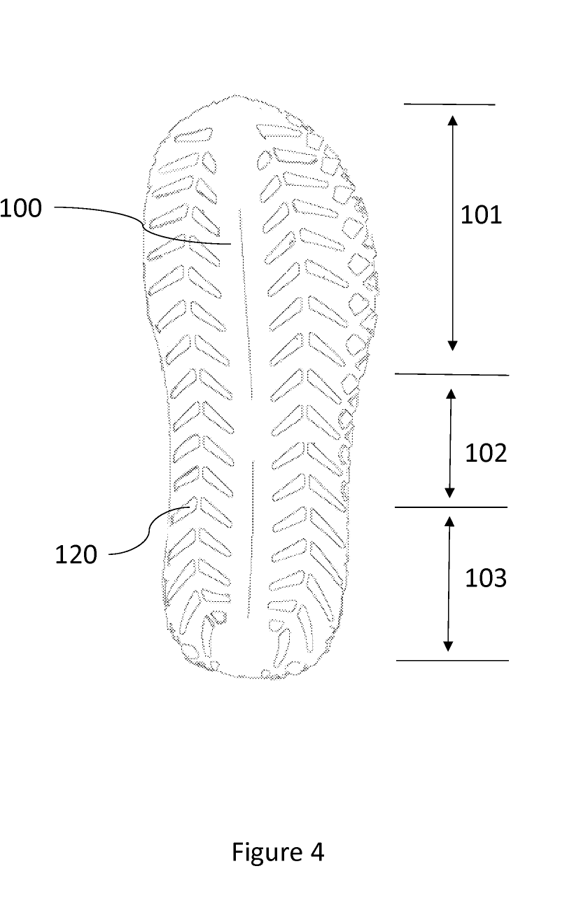

FIG. 4 shows the bottom of the scent masking overshoe 100 covering the boot 200. The anti-slip pattern structure 120 of the overshoe 100 forms downward protrusions, wherein the thickness of the protrusions varies according to their positions on the sole, preferably the protrusions on general pressure points for foot supporting shall be thicker, i.e. the protrusions of the front sole portion 101 and of the heel portion 103 shall be thicker than the ones on the foot arch 102. Therefore, the anti-slip pattern structure 120 plays two roles at the same time, as anti-slip and strength enhancing for preventing being punctured.

The thickness at the front sole portion 101 and the heel 103 is set to 2.0 to 2.5 mm, and the thickness at the arch portion 102 is 1.5 to 2.0 mm, which can not only ensure the structural strength and cushioning effect, but also reduce the overall weight.

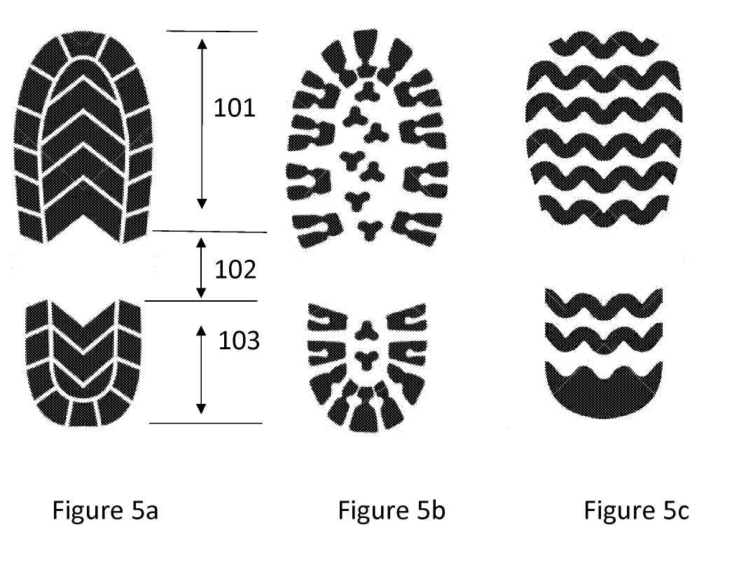

FIGS. 5a, 5b, 5c are other anti-slip pattern designs for the bottom of the overshoe, such as the structure enhancing and anti-slip portion is formed only on the front sole portion and of the heel portion, of the sole bottom of the scent masking overshoe 100.

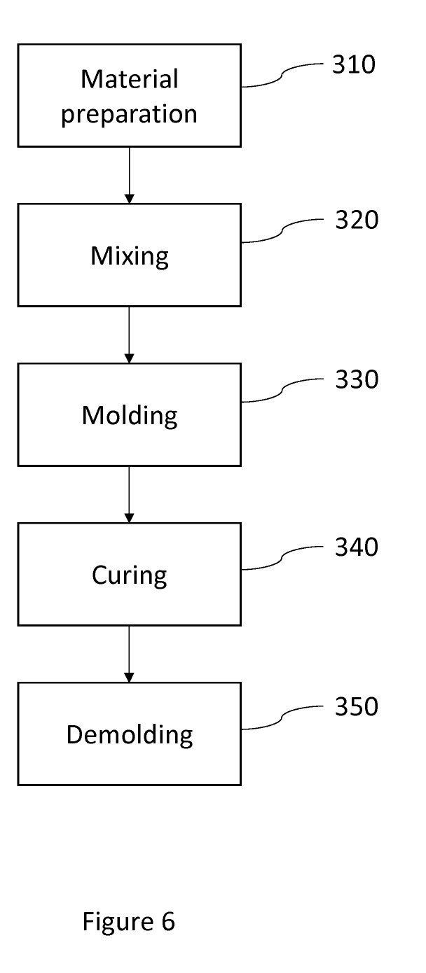

As shown in FIG. 6, the production process of overshoes for the hunter’s boots will be described below.

### Material preparation step 310

After experimental comparisons, the main material of the overshoe of this invention is silicone polymer. Compared with ordinary rubber, silicone polymer is superior in many physical and chemical aspects. The specific experimental results are as follows:

Tensile fatigue tests: ordinary rubber such as natural rubber may have obvious cracks after about 30,000 cycles of stretching when the tensile strength is about 8MPa; silicone polymer can withstand about 30,000 cycles of stretching without obvious cracks under the same tensile strength of 8MPa.

Performance retention tests after heat aging: after 1000 hours of heat aging at 150℃, the tensile strength retention rate of natural rubber is about 60%; after 1000 hours of heat aging at 200℃, the tensile strength retention rate of silicone polymer can still reach about 80%.

Ozone aging resistance tests: natural rubber may have obvious cracks after exposure to an ozone concentration of 50pphm for 100 hours; silicone polymer is exposed to the same ozone concentration of 50pphm for 500 hours, and the appearance is basically unchanged.

The raw materials for the overshoe according to the present invention, comprises a silicone polymer, a cross-linking agent, a reinforcing agent, and a catalyst.

The silicone polymer could be selected from: polydimethylsiloxane (PDMS), polyvinyl siloxane (PVS), and methyl phenyl polysiloxane (PMPS).

When the polyvinyl siloxane (PVS) contains 1.5% to 2% of the vinyl, the curing speed is fast and the heat resistance of the product can reach 250° C, but the material cost is higher and the processing performance is slightly poor.

When the methyl phenyl polysiloxane (PMPS) contains 10% to 15% of phenyl, the low-temperature performance is excellent, as the product can maintain good elasticity at -70° C, but the mechanical properties are slightly lower than those of other silicone polymer.

Thus the main material of the overshoe of the present invention is polydimethylsiloxane (PDMS), being 84 to 96 weight percent of the materials; when the proportion is too low (<84%), the performance foundation of silicone polymer will be weak, while the proportion is too high (>96%), other properties will be difficult to improve, as the proportions of the cross-linking agent, the reinforcing agent, and the catalyst are too low to play their respective roles.

The cross-linking agent is a hydrogen silicone oil, being 1 to 8 weight percent of the materials. When the proportion is too low, the cross-linking process is insufficient so that the overshoe product will be too soft and easy to get punctured and broken; if the proportion is too high, the overshoe product may become too hard and be difficult to put on the boots.

The reinforcing agent is a white fumed silica, being 3 to 15 weight percent of the materials. If the proportion is lower than 3%, the reinforcement effect is poor, and if it is higher than 15%, the processing difficulty for molding may increase and the hardness of the overshoe product may increase excessively, so as to be difficult to put on the boots and easy to crack.

The catalyst could be platinum compounds, dibutyltin dilaurate, or stannous octoate, being 2 to 20 ppm. When the proportion is too low, the producing process will result in a slow reaction speed, while the proportion is too high, it may lead to higher costs and potential performance instability.

In an optimal embodiment of the invention, the polydimethylsiloxane being 87 to 92 weight percent of the materials; the hydrogen silicone oil being 3 to 5 weight percent of the materials; the white fumed silica, being 5 to 10 weight percent of the materials; and the platinum compound catalyst, being 5 to 10 ppm. Such a component ratio can make the silicone overshoe have better comprehensive properties, good mechanical properties, temperature resistance, weather resistance, moderate elasticity and strength, faster production speed and lower cost.

The scent masking overshoe in the present invention could be unscented as the above mentioned formulas, or be scented to mimic the natural odor.

In an optimal embodiment of the invention, the materials further comprise a scent additive, being 0.2 to 1 weight percent of the raw materials, preferably being 0.5 to 0.8 weight percent.

The scent additive is one of the following flavors: vanilla, anise, licorice and synthetic formulas. The synthetic formulas could mimic the urine odor of the local wild animals.

### Mixing step 320

The raw materials prepared according to the above mentioned formulas could be mixed in a rubber mixer, such as a two roll open mill mixer, an internal mixer or a kneader. The materials are fed into the mixer in an order of the silicone polymer, the reinforcing agent, the cross-linking agent, and the catalyst. The scent additive and/or other additives could be added lastly.

The silicone polymer is liquid state of polydimethylsiloxane (PDMS), which facilitates the mixing; the cross-linking agent could be powder of peroxide cross-linking agent or liquid of hydrogen silicone oil, both can be mixed with PDMS easily.

The reinforcing agent is small particle powder of white fumed silica, which could be mixed in PDMS so as to be evenly dispersed in the cross-linked silicone polymer matrix to enhance the mechanical properties.

The catalyst could be liquid of platinum compounds, powder of dibutyltin dilaurate, or powder of stannous octoate, and a good uniform mixing helps lower catalyst usage and higher production speed.

The scent additive could liquid essence for easy mixing, or could be in microencapsulated solid powder form for slow releasing the scent.

Generally speaking, as temperature increases, molecular motion intensifies, which increases the mixing speed, but a too high temperature may cause some ingredients to deteriorate. After tests, a batch of the raw materials of the present invention is mixed in the mixer at 30 ℃ to 40 ℃ until evenly mixed, generally about 20 to 30 minutes.

### Molding step 330

The parts of the mold for the overshoe are designed or selected according to the size and/or shape of the overshoe. Optionally, a mold preparing step is performed before the molding step, such as cleaning the mold parts and/or applying a release agent to the surfaces of the mold parts, so as to facilitate demolding afterward.

The mold parts could be assembled to form a mold cavity, and the overshoe can be molded by an injection molding procedure or a compression molding procedure.

In the injection molding procedure, first, the parts of the mold are clamped together to form the mold cavity; then, the mixed materials are injected into and fill the mold cavity under pressure.

In the compression molding procedure, first, the mixed materials are loaded into the opened / unclamped mold cavity, i.e. onto a lower part of the mold; then, applying pressure to the parts of the mold to clamp and form the mold cavity, while the mixed materials are squeezed and fill the mold cavity.

### Curing step 340

While the mold cavity is formed and filled with the mixed materials, by the injection molding procedure or the compression molding procedure, as described above, the materials are cured to the overshoe product by a cross-linking process.

The cross-linking process is performed for 40 to 50 seconds, under the conditions of 145 to 155 degrees Celsius and pressure of 150 to 200 psi, by applying heat and pressure to the parts of the mold.

The temperature ranges of 145-155 degrees Celsius is to make the substances involved in the cross-linking reaction (such as polymers, cross-linking agents, etc.) have appropriate reactivity. If the temperature is too low, the reaction rate is slow, and it is difficult to complete sufficient cross-linking within the specified time; if the temperature is too high, it may cause material degradation, side reactions and other problems.

The pressure of 150-200 psi helps the reactants to be in close contact and promote the cross-linking reaction. At the same time, it can also keep the material in a certain shape and density during the reaction process, and prevent the appearance of defects such as bubbles and holes at high temperatures.

The reaction time of 40-50 seconds is determined by comprehensively considering the reaction rate and production efficiency. If the time is too short, the cross-linking reaction is incomplete and the material performance does not meet the requirements; if the time is too long, the production efficiency is reduced, and the material performance may also deteriorate.

### Demolding step 350

After finishing the curing step, open the mold parts and remove the overshoe from the mold. The demolding step is performed, either manually by a worker, or by blowing air.

The scented overshoe should be packaged for preserving the scent soon after demolding, such as in vacuum-sealed or foil packs.

In an optimized embodiment, considering that the overshoe is mainly used for outdoor walking, anti-slip performance is very important, so the anti- slip performance is enhanced from both material and structural aspects.

To improve the anti-slip performance of the overshoe, a UV anti-slip additive is further added to the raw materials before the mixing step.

The UV anti-slip additive is 2 to 8 weight percent of the raw materials, and comprises a silicone-modified acrylate oligomer and a photoinitiator.

The ratio of the silicone-modified acrylate oligomer to the photoinitiator is about 6:1 to 10:1.

The photoinitiator could be 2-Hydroxy-2-methylpropiophenone.

To cure a UV anti-slip layer on the surface of the disposable overshoe, a UV curing step is performed by UV light source located at about 7 to 20 cm from a sole bottom surface of the overshoe for about 30 to 90 seconds, after the cross-linking process and before the demolding step. Preferably the UV curing is performed by UV light source located at 10 cm from a sole bottom surface of the overshoe for 50 to 70 seconds.

The UV anti-slip layer on the bottom surface of the overshoe increase the friction while walking; meanwhile, the inner surface of the disposable overshoe will also produce a friction-increased layer. This layer will help better fix the position of the overshoe and the boot, thereby providing a better wearing experience, namely, reducing the relative sliding between the overshoe and the boot.

### Friction coefficient testing results

As the proportion of the UV anti-slip additive increases from 2% to 8%, the static friction coefficient of the sole surface of the overshoe increases from 0.50 to 0.75, and the dynamic friction coefficient increases from 0.40 to 0.65. This shows that the UV anti-slip additive can effectively improve the anti-slip performance of silicone overshoe, and the higher the proportion of the additive, the better the anti-slip effect. However, when the proportion is too high (>8%), the elasticity and strength of the overshoe decrease, thus the overshoe becomes easy to crack and break.

The friction coefficient also increases when the irradiation time is extended from 30s to 90s, and the increase slows down after 60s. At 90s, the static friction coefficient reaches 0.78 from 0.75 (60 seconds), and the dynamic friction coefficient reaches 0.68 from 0.65 (60 seconds). Considering energy consumption and efficiency,60s is more suitable.

Furthermore, as shown in FIGS. 4, 5a, 5b, 5c, anti-slip texture pattern designs are set on the bottom surface of the sole of the overshoe, so as to increase the friction between the sole and the ground.

As shown in FIG. 4, the anti-slip texture pattern is set on the entire sole surface, and the thickness of the protruding part of the texture pattern is relatively uniform. Such design facilitates the design of the mold part, i.e. lowers the total production costs, also it eases the fitness between the overshoe and the boot, namely, such as easily matching the location of the heel portion of the overshoe to the heel of the boot.

On the other hand, after several walking trials, the results show that the disposable overshoe could be punctured on several typical spots after one-day walking in the wild field, as partially failure of the scent masking purpose. These typical spots are the main points of force while walking, as the forefoot and the heel. It is understandable that these spots are subject to the most pressure and friction when walking, thus it is preferable to increase the thickness on these spots, as well as maintain the anti-slip function.

As shown in FIGS. 5a, 5b, 5c, the protrusion parts of the anti-slip pattern set on the bottom surface of the overshoe, locate at the front sole portion 101 and the heel portion 103. Namely, the front sole portion 101 and a heel portion 103 of the overshoe is thicker than an arch portion 102 of the overshoe, so as to maintain a sealed structure of the disposable overshoe after taking the friction and the pressure of the at least one-day walking.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Finally, those skilled in the art should appreciate that they can readily use the disclosed conception and specific embodiments as a basis for designing or modifying other structures for carrying out the same purposes of the present invention without departing from the spirit and scope of the invention as defined by the appended claims.

What is claimed is:

1. A method of manufacturing an overshoe for footwear, comprising:
mixing raw materials, comprising a silicone polymer, a cross-linking agent, a reinforcing agent, and a catalyst;
molding the overshoe by one of:
injecting the mixed material into a mold cavity; and
compression molding the mixed materials in a mold cavity;
curing the molded material by a cross-linking process; and
removing the cured overshoe from the mold cavity.

2. The method of claim 1, wherein the silicone polymer is a polydimethylsiloxane.

3. The method of claim 2, wherein the polydimethylsiloxane is 84 to 96 weight percent of the materials.

4. The method of claim 2, wherein the cross-linking agent is a hydrogen silicone oil, being 1 to 8 weight percent of the materials.

5. The method of claim 2, wherein the reinforcing agent is a white fumed silica, being 3 to 15 weight percent of the materials.

6. The method of claim 2, wherein the catalyst is one of platinum compounds, dibutyltin dilaurate, and stannous octoate, being 2 to 20 ppm.

7. The method of claim 2, wherein the polydimethylsiloxane being 87 to 92 weight percent of the materials; the hydrogen silicone oil being 3 to 5 weight percent of the materials; the white fumed silica, being 5 to 10 weight percent of the materials; and the platinum compound catalyst, being 5 to 10 ppm.

8. The method of claim 1, wherein the materials further comprise a scent additive, being 0.2 to 1 weight percent of the raw materials.

9. The method of claim 8, wherein the scent additive, being 0.5 to 0.8 weight percent of the raw materials.

10. The method of claim 8, wherein the scent additive is one of the following flavors: vanilla, anise, licorice and synthetic formulas mimicing a urine odor of a local wild animal.

11. The method of claim 1, wherein the cross-linking process is performed for 40 to 50 seconds, under the conditions of 145 to 155 degrees Celsius and a molding pressure of 150 to 200 psi.

12. The method of claim 1, wherein the materials further comprise a UV anti-slip additive; the method further comprises a step of UV curing.

13. The method of claim 12, wherein the UV anti-slip additive, being 2 to 8 weight percent of the raw materials, comprises a silicone-modified acrylate oligomer and a photoinitiator.

14. The method of claim 13, wherein the ratio of the silicone-modified acrylate oligomer to the photoinitiator is 6:1 to 10:1.

15. The method of claim 12, wherein the UV curing is performed by UV light source located at 7 to 20 cm from a sole bottom surface of the overshoe for 30 to 90 seconds.

16. The method of claim 15, wherein the UV curing is performed by UV light source located at 10 cm from a sole bottom surface of the overshoe for 50 to 70 seconds.

17. A disposable overshoe manufactured by the method of claim 1, wherein at least one of a front sole portion and a heel portion of the overshoe is thicker than an arch portion of the overshoe.

18. The overshoe of claim 17, wherein at least one anti-slip pattern is formed on the bottom surface of the overshoe.

19. The overshoe of claim 18, wherein at least one anti-slip pattern forms protrusion parts located on the bottom surface of a front sole portion and a heel portion of the overshoe.
